(19) United States
(12) Patent Application Publication
(10) Pub. No.: US 2013/0099109 A1
(43) Pub. Date: Apr. 25, 2013

(54) IMAGE READING DEVICE AND IMAGE READING SYSTEM

(71) Applicants: Ming-Tsan KAO, Hsin-Chu (TW); Han-Ping CHENG, Hsin-Chu (TW); Shu-Sian YANG, Hsin-Chu (TW)

(72) Inventors: Ming-Tsan KAO, Hsin-Chu (TW); Han-Ping CHENG, Hsin-Chu (TW); Shu-Sian YANG, Hsin-Chu (TW)

(73) Assignee: PIXART IMAGING INC., Hsin-Chu (TW)

(21) Appl. No.: 13/540,977

(22) Filed: Jul. 3, 2012

(30) Foreign Application Priority Data
Oct. 19, 2011 (TW) 100137824

(51) Int. Cl. G06K 7/12

(52) U.S. Cl. 250/271

(57) ABSTRACT

An image reading device and an image reading system for recognizing a first image in a selected area on an object are provided. The selected area includes a first portion and a second portion, wherein the first portion is coated with an invisible ink, which is capable of absorbing the first light with a wavelength of invisible light, while the second portion is capable of reflecting the second light with the wavelength of invisible light. The image reading device comprises a main body and an optical element disposed on the main body. The optical element receives the second light corresponding to the second portion to recognize the first image corresponding to the first portion. The image reading system further comprises a processing device which is configured to resolve the first image into corresponding information content.

This application claims the benefit of the priority to Taiwan Patent Application No. 100137824 filed on Oct. 19, 2011, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides an image reading device and an image reading system, which are particularly suitable for recognizing an image formed by an invisible ink capable of absorbing a light with a wavelength of invisible light.

2. Descriptions of the Related Art

An approach that is currently known to codify information in a unified way is to use barcodes. The barcode system has now become fairly sophisticated and related standards have been formulated. Information can be firstly converted into a barcode and then, if necessary later, the information embedded in the barcode can be obtained rapidly by using a particular reading device to read the barcode. By using a scanner to convert the barcode into data for input into a computer, time and errors can be significantly reduced and the speed at which the data is inputted can be increased as well when compared to conventional manual or keyboard input. If appropriate application software is further used in combination, then the data can be processed and managed more efficiently.

Barcodes are commonly used in daily living, for example, on various commodity packages, parking bills, credit card bills and even webpages.

A common barcode is a one-dimensional (1D) barcode, which consists of alternating white and black rectangular lines with different thicknesses in parallel with each other. These lines are combined according to a coding rule to form a symbol representing letters, numerals or the like. When the 1D barcode is recognized, an infrared scanner is usually used to obtain a group of reflected optical signals, which are then converted and decoded into corresponding letters and numerals to be transmitted to a computer for subsequent analysis and application.

In detail, as shown in FIG. 1, an object 11 (e.g., a book) is attached with a barcode 13. The barcode 13 is a 1D barcode formed by alternating white and black lines in parallel with each other and may be embedded with information, such as publication information. When a user places an infrared scanner 15 above the barcode 13, the infrared scanner 15 can project a scan light and then obtain reflected optical signals. The reflected optical signals can be interpreted after being transmitted to a computer system (not shown). Conceivably, the barcode system is much suitable for use in retail bookstores or book management.

Apart from the aforesaid 1D barcode, a two-dimensional (2D) barcode is further developed to cater for demands in applications. The 2D barcode is presented by many micro black cells distributed in a grid. The user can obtain related information by using a camera to capture the image. The 2D barcode is advantageous in that it can record more data and more complicated information content such as a large amount of characters, websites or even pictures.

However, regardless of the forms of the barcodes of the prior art, the barcodes currently available are all attached, printed or displayed on an object in such a way that they are visible to the naked eye. Although the barcodes can be miniaturized, this is limited by the resolution of the scanner or the camera. Moreover, the prior art barcodes must still be viewed by the user with the naked eye for subsequent operations, so the size of the barcodes should not be too small. Consequently, the barcodes will certainly take up a considerable area, which affects the presentation of the object itself to some extent. For example, the barcode 13 shown in FIG. 1 partially covers an original pattern on the object 11. Apart from damaging the original design of the object and affecting the appearance, this will cause more trouble to the user if important information is covered (e.g., the position of the barcode 13 on the object 11 is originally printed with an author' name).

Accordingly, it is important to provide an image reading device and an image reading system for processing barcodes of new forms, which is expected to bring revolutionary application to the barcode system.

### SUMMARY OF THE INVENTION

An objective of the present invention is to provide an image reading device and an image reading system, which are particularly suitable for recognizing an image or a barcode on an object that is formed by invisible ink. The image or the barcode can be completely ignored visually in a general environment and, thus, will not affect the visual effect presented by the object itself.

The invisible ink allows a light with a wavelength of visible light to pass therethrough without causing any influence and absorbs lights with particular wavelengths other than visible light (i.e., invisible light).

When the image reading device of the present invention emits invisible light with a particular wavelength, a part of the invisible light will be absorbed by the invisible ink. After the image reading device obtains some reflected optical signals, a processing device of the image reading system can interpret the reflected optical signals and further resolve the barcode or the image into corresponding information content.

From the viewpoint of a user, the image or the barcode formed by the invisible ink can be completely ignored visually and the original pattern presented on the object is completely free from the influence of the image or the barcode. Moreover, because the light emitted from the image reading device is invisible, the light cannot be viewed with the naked eyes without using any instrument.

Another objective of the present invention is to provide an image reading device and an image reading system as tools for classifying information and extending auxiliary information. More specifically, information originally presented on the object may act as the primary information which can be recognized with the naked eye; and the auxiliary information is obtained through the image reading device and the image reading system. Conceivably, the presentation of the object can be made simpler and neater by presenting only the primary information, and the user can determine whether to use the image reading device and the image reading system to obtain the extended auxiliary information.

Furthermore, the present invention is still suitable for use in the existing products. In detail, the existing products can be additionally processed by using an invisible ink to spray extended auxiliary information thereon. The user can then determine whether to use the image reading device and the image reading system of the present invention as tools for data connection. This makes the application scope wider.

To achieve the aforesaid objective, the present invention provides an image reading device for recognizing the first image in a selected area on an object. The selected area includes a first portion and a second portion. The first portion is coated with an invisible ink for absorbing a first light with a wavelength of invisible light and the second portion is capable of reflecting a second light with a wavelength of invisible light. The image reading device comprises a main body and an optical element. The optical element is disposed on the main body to receive the second light corresponding to the second portion to recognize the first image corresponding to the first portion.

The present invention further provides an image reading system, which comprises the aforesaid image reading device and further has a processing device configured to resolve the first image into corresponding information content.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional barcode system;

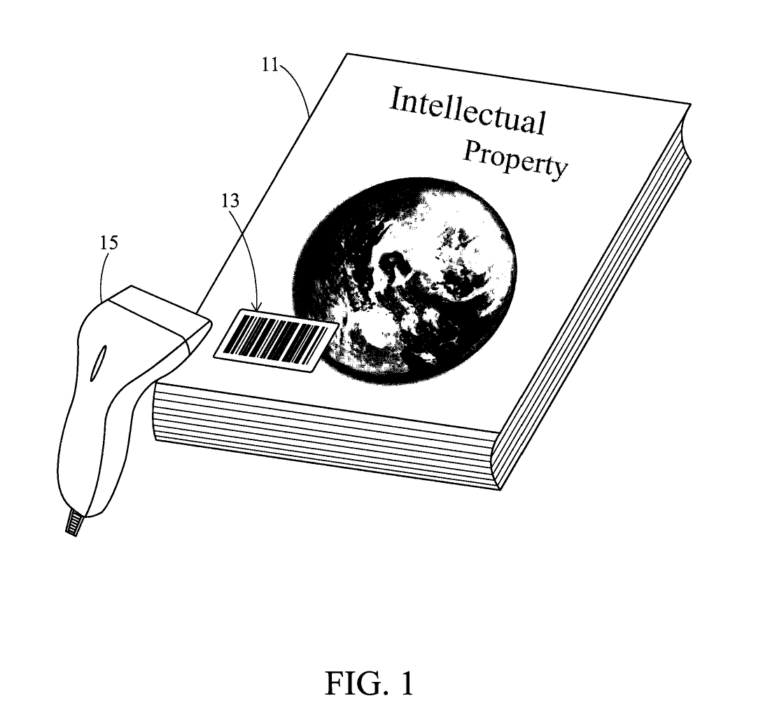

FIG. 2 is a schematic view illustrating an object and a barcode in a general environment in application of the present invention;

FIG. 3 is a schematic view of the first embodiment of the present invention;

FIG. 4 is a schematic view of the second embodiment of the present invention;

FIG. 5 is a schematic view of the third embodiment of the present invention;

FIG. 6 is a schematic view of the fourth embodiment of the present invention; and

FIG. 7 is a schematic view illustrating the application of an image reading device of the present invention.

### DESCRIPTION OF THE PREFERRED EMBODIMENT

In the following descriptions, the present invention will be explained with reference to embodiments thereof. However, the description of these embodiments is only for the purpose of illustration rather than limitation. It shall be appreciated that in the following embodiments and the attached drawings, elements not directly related to the present invention are omitted from depiction; and dimensional and positional relationships among individual elements in the attached drawings are illustrated only for ease of understanding but not to limit the actual scale.

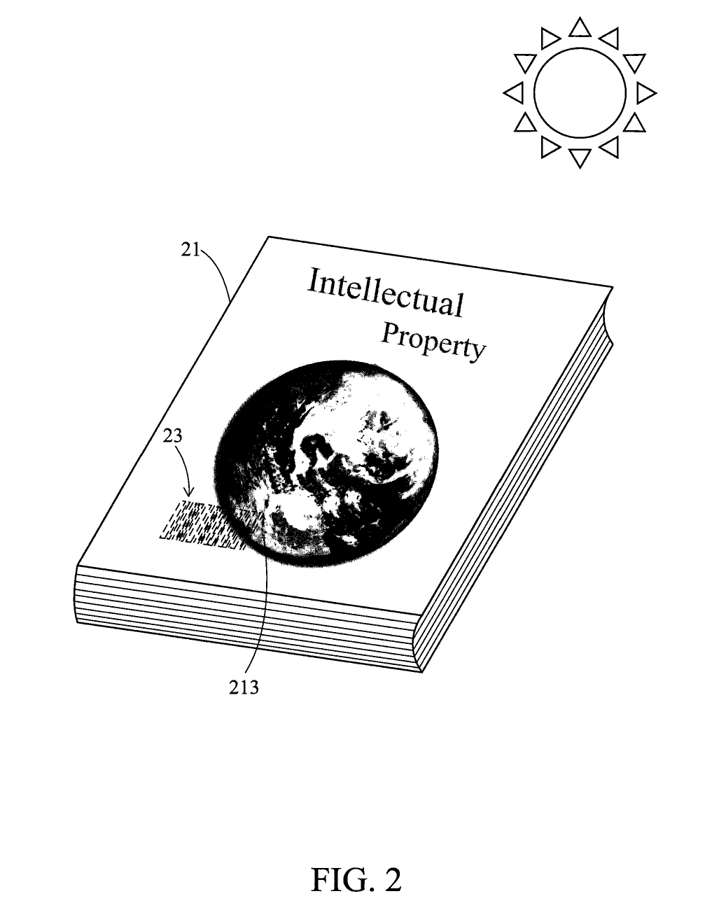

First, the first embodiment of the present invention will be described. FIG. 2 illustrates a schematic view of an object 21 in a general environment. The object 21 is illustrated as a book in this embodiment; and as can be understood, the object 21 may be various types of products, and the present invention has no limitation thereon.

In this embodiment, an invisible ink is used to form a first image 23 on the object 21. As the invisible ink is used, the first image 23 allows visible light to pass therethrough in the general environment, so it has no effect on the visual appearance of the object 21 and presents an approximately transparent state. That is to say, although the first image 23 formed by the invisible ink may be partially overlapped with a visible second image 213 (e.g., an earth pattern that is shown in FIG. 2 and can be recognized with the naked eye) originally presented on the object 21, a portion of the second image 213 that is overlapping with the first image 23 will not be masked because the first image 23 has no effect on the visual appearance. It shall be appreciated that to indicate that the first image 23 has no effect on the visual appearance, the first image 23 is depicted by dashed lines in FIG. 2 and the portion of the second image 213 that is covered can still be clearly seen at positions where the first image 23 and the second image 213 are overlapping.

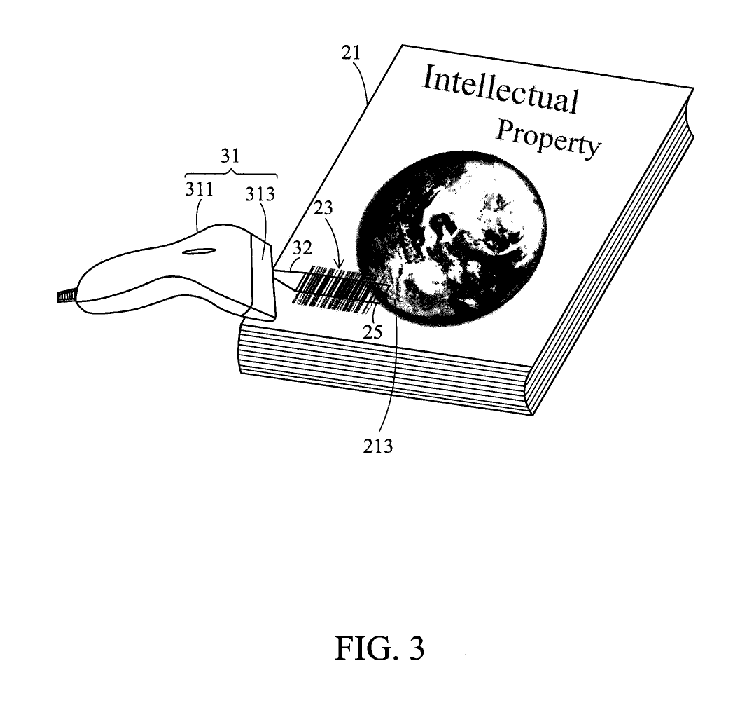

FIG. 3 illustrates a schematic view of the operation of an image reading device 31 of the present invention. The image reading device 31 comprises a main body 311 and an optical element 313 disposed on the main body 311. When the image reading device 31 is activated, the optical element 313 will project a light 32 with a wavelength of invisible light, for example, ultraviolet (UV) light, infrared light or any other light with a particular wavelength falling outside the wavelength range of visible light onto the object 21. Preferably, the light 32 will not excite any visible light when being projected to the invisible ink; i.e., in the present invention, the light 32 cannot be viewed with the naked eyes all along without using an instrument.

For example, the invisible light 32 will form a selected area 25, which may also be understood as a visual field range of the optical element 313. The selected area 25 includes a first portion and a second portion. The first portion is coated with invisible ink, while the second portion is not coated with the invisible ink. A portion of the light 32 that is projected to the first portion is a first light, and a portion of the light 32 that is projected to the second portion is a second light.

More specifically, the invisible ink chosen in the present invention further absorbs a light with a wavelength of invisible light along with the visible light that is allowed to pass therethrough. Therefore, when the light 32 is projected to the object 21 to form the selected area 25, the first light corresponding to the first portion will be absorbed by the invisible ink and the second light corresponding to the second portion will not be absorbed but be reflected and then be received by the optical element 313. In this way, the first image 23 corresponding to the first portion is recognized in the selected area 25. Therefore, as shown in FIG. 3, the first portion coated with the invisible ink is depicted by black lines and the second portion not coated with the invisible ink is depicted by white lines. Generally, an area of the first portion is greater than an area of the second portion.

In this embodiment, a common one-dimensional (1D) barcode will be taken as an example. The 1D barcode consists of a plurality of alternating thick and thin lines, and the so-called first image 23 may be all of or at least a part of the 1D barcode; e.g., the selected area 25 of FIG. 3 covers a portion of the entire first image 23. In either case, embedded information content can be resolved from the first image 23.

Furthermore, as can be seen from FIG. 3, the selected area 25 covers a portion of the second image 213; i.e., the first image 23 is allowed to be partially or completely overlapped with the second image 213. As compared with FIG. 2, only when the image reading device 31 projects the light 32 with the wavelength of invisible light, can the first image 23 be recognized by the image reading device 31. Therefore, the second image 213 will not be masked and become unrecognizable.

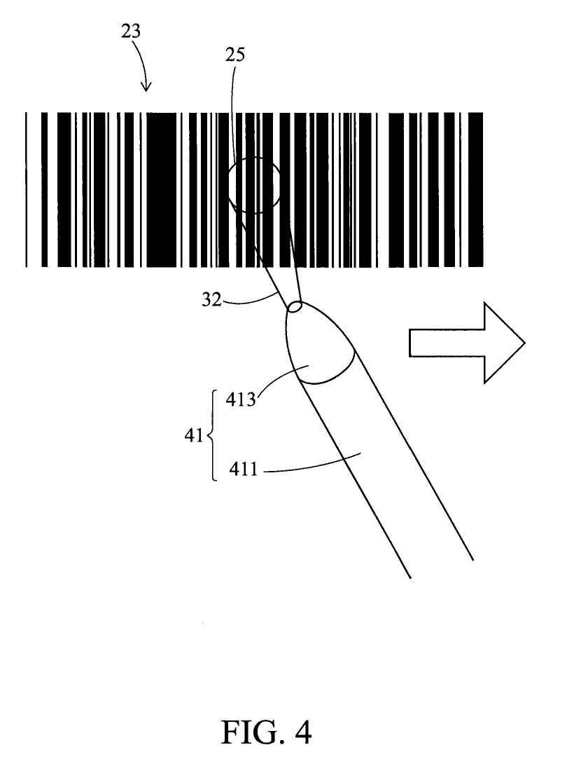

The second embodiment of the present invention is shown in FIG. 4. An image reading device 41 of this embodiment also comprises a main body 411 and an optical element 413. This embodiment differs from the first embodiment in that the selected area 25 formed by the light 32 projected from the optical element 413 only occupies a part of the first image 23. In this case, if the user moves the image reading device 41 in a proper direction (e.g., from left to right as shown in FIG. 4) to record the pattern of the first image 23 completely and continuously, then the information content carried by the first image 23 can also be recognized by the image reading device 41. Therefore, this also represents a practicable implementation.

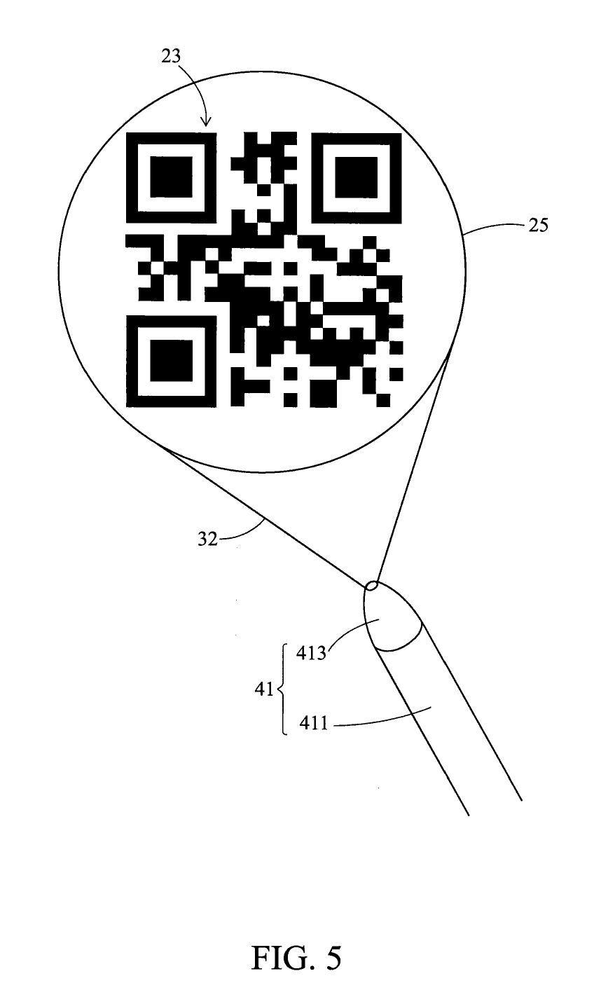

The third embodiment of the present invention is shown in FIG. 5. The first image 23 of this embodiment may also be a two-dimensional (2D) barcode. In this case, the selected area 25 may cover the first image 23 completely, or cover only a part of the first image 23. In terms of the 2D barcode, the area of the first portion (i.e., the black portion) is usually less than the area of the second portion (i.e., the white portion) just as is conventionally known. In this 2D barcode shown in FIG. 5, the boxes at the three corners are mainly used for recognition and will not be further described herein. Similarly, after the light 32 with the wavelength of invisible light is projected from the optical element 413, the first light projected to the first portion (i.e., the black portion) coated with the invisible ink is absorbed by the invisible ink and the second light projected to the second portion (i.e., the white portion) not coated with the invisible ink is reflected and then received by the optical element 413. In this way, the first image 23 can be recognized.

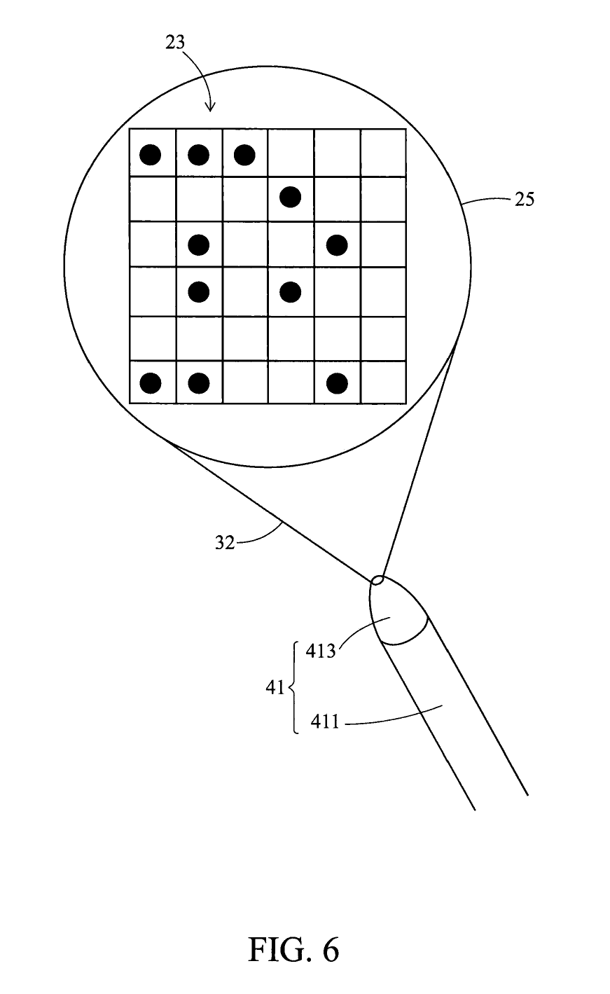

In the fourth embodiment of the present invention as shown in FIG. 6, the first image 23 may be a 2D barcode of another form. The first image 23 comprises a plurality of micro dots formed by selectively coating the invisible ink in a matrix grid; i.e., the first portion consists of black round dots shown in FIG. 6, while the second portion is the remaining blank portion. Similarly, because the first light projected to the first portion (i.e., the black round dot portion) is absorbed by the invisible ink and the second light projected to the second portion (i.e., the white portion) is reflected and then received by the optical element 413, the first image 23 can be recognized. It shall be appreciated that the micro dots in the first image 23 are preferably distributed according to a certain rule (e.g., some of the micro dots being a header area and some of the micro dots being a data area). In this way, after the first image 23 is recognized, the system can rapidly find the header area firstland then find the data area according to the rule to obtain related encoded information and interpret the information.

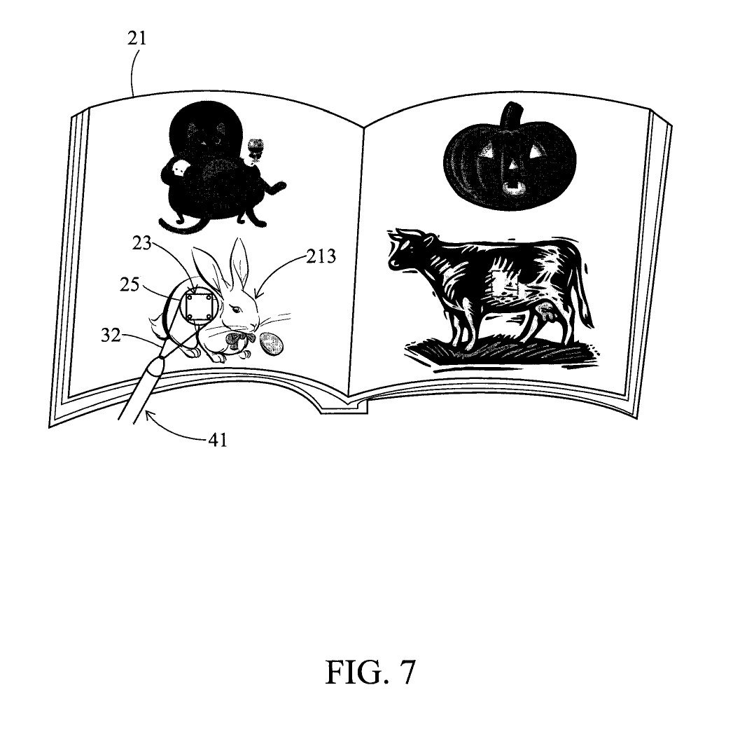

The fifth embodiment of the present invention provides an image reading system. The image reading system may comprise the image reading devices 31, 41 of the aforesaid embodiments; the related details of which will not be further described herein. The image reading system of this embodiment further comprises a transmission device, a processing device and an output device. In reference to FIG. 7, after the information contained in the first image 23 is captured by the image reading device (the image reading device 41 in this embodiment), the required information can be transmitted from the image reading device 41 to the processing device (not shown; e.g., a microprocessor) via the transmission device (not shown; e.g., a transmission line or a wireless signal emitter) to resolve the first image 23 into corresponding information content (i.e., related auxiliary information corresponding to the second image 213). Then, the output device (not shown; e.g., a display or a loud speaker) can further output or present the information content.

Furthermore, FIG. 7 shows an embodiment in which the image reading device and the image reading system of the present invention are applied to a children's book. As shown, the object 21 is printed with a plurality of patterns (i.e., the second image 213), which is the primary information of the object 21 that is to be presented to the user and can be recognized with the naked eye. Each of the patterns is further coated with the invisible ink at a particular position thereof to form the first image 23. The invisible ink cannot be viewed with the naked eye. After being activated by the user, the image reading device 41 will project invisible light (which cannot be viewed by the user either) onto the first image 23. The first portion of the first image 23 that is coated with the invisible ink will absorb the first light, while the second portion not coated with the invisible ink will not absorb the second light, so the second light is finally reflected and received by the image reading device 41.

In the image reading system, the first image 23 can be recognized by the image reading device 41 according to the light received. Then, the first image 23 is transmitted via the transmission device to the processing device so that information content contained in the first image 23 can be resolved. The information content is additional auxiliary information. Then, the information content is further outputted or presented by the output device. For example, a loud speaker disposed at the back end can make corresponding pronunciations or term explanations, a display can present pre-stored static photos or dynamic films or even stories, or a webpage can be linked to further webpages. The aforesaid example of the children's book is only illustrative and is not intended to limit the present invention. The present invention is also suitable for users of various age groups and for various types of products. The technology of the present invention helps to classify information into primary information and auxiliary information, in which the primary information is recognizable to the naked eye while the auxiliary information is obtained through the image reading device and the image reading system. The advantages of the present invention lie in that it eliminates the need of presenting all the information through conventional printing and can prevent the primary information and the auxiliary information from being confounded or interfering with each other. Furthermore, by simply spraying a particular barcode onto an existing product by using the visible ink, the existing product can be re-processed into a product with extended auxiliary information. Then, the existing product will also be suitable for use with the image reading device and the image reading system of the present invention. In this case, the invisible ink and the image reading system can be viewed as tools for data connection, and this makes the application scope wider.

According to the above descriptions, the image reading device and the image reading system of the present invention are used in combination with the image or the barcode formed by the invisible ink that allows visible light to pass therethrough but absorbs invisible light. The image or the barcode is invisible and, consequently, does not affect the visual effect of the object itself in general environments. Once the image reading device emits invisible light to the image or the barcode, the image or the barcode can be recognized and further resolved into corresponding information content.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An image reading device for recognizing a first image in a selected area on an object, wherein the selected area includes a first portion and a second portion, in which the first portion is coated with an invisible ink for absorbing a first light having a wavelength of invisible light and the second portion is capable of reflecting a second light having the wavelength of invisible light, the image reading device comprising:
a main body; and
an optical element disposed on the main body to receive the second light corresponding to the second portion, so as to recognize the first image corresponding to the first portion.

2. The image reading device as claimed in claim 1, wherein the first image is embedded with information content.

3. The image reading device as claimed in claim 2, wherein the first image is at least a portion of a one-dimensional barcode.

4. The image reading device as claimed in claim 3, wherein an area of the first portion is greater than an area of the second portion.

5. The image reading device as claimed in claim 2, wherein the first image is a two-dimensional barcode.

6. The image reading device as claimed in claim 5, wherein an area of the first portion is less than an area of the second portion.

7. The image reading device as claimed in claim 1, wherein the selected area is further formed with a second image which is visible.

8. The image reading device as claimed in claim 7, wherein the first image and the second image are able to be partially overlapped.

9. An image reading system for recognizing a first image in a selected area on an object, wherein the selected area includes a first portion and a second portion, in which the first portion is coated with an invisible ink for absorbing a first light having a wavelength of invisible light and the second portion is capable of reflecting a second light having the wavelength of invisible light, the image reading system comprising:
an image reading device comprising a main body and an optical element, wherein the optical element is disposed on the main body to receive the second light corresponding to the second portion, so as to recognize the first image corresponding to the first portion; and
a processing device being configured to resolve the first image into corresponding information content.

10. The image reading system as claimed in claim 9, further comprising a transmission device for transmitting the first image from the image reading device to the processing device.

11. The image reading system as claimed in claim 9, further comprising an output device for outputting the information content.

12. The image reading system as claimed in claim 9, wherein the first image is at least a portion of a one-dimensional barcode.

13. The image reading system as claimed in claim 12, wherein an area of the first portion is greater than an area of the second portion.

14. The image reading system as claimed in claim 9, wherein the first image is a two-dimensional barcode.

15. The image reading system as claimed in claim 14, wherein an area of the first portion is less than an area of the second portion.

16. The image reading system as claimed in claim 9, wherein the selected area is further formed with a second image which is visible.

17. The image reading system as claimed in claim 16, wherein the first image and the second image are able to be partially overlapped.
